(19) United States
(12) Patent Application Publication
(10) Pub. No.: US 2011/0048963 A1
(43) Pub. Date: Mar. 3, 2011

(54) METHOD OF MANUFACTURING ELECTROPOLISHING PAD

(75) Inventors: Shinji Shimizu, Osaka-shi (JP); Sachiko Nakajima, Osaka-shi (JP); Hiroyuki Okumura, Osaka-shi (JP); Satoshi Maruyama, Osaka-shi (JP); Takashi Oga, Osaka-shi (JP)

(73) Assignee: TOYO TRIE & RUBBER CO., LTD., Osaka-shi (JP)

(21) Appl. No.: 12/863,410

(22) PCT Filed: Jan. 7, 2009
(86) PCT No.: PCT/JP2009/050049

§ 371 Date: Jul. 16, 2010

(30) Foreign Application Priority Data
Jan. 18, 2008 (JP) 2008-009477
Jan. 18, 2008 (JP) 2008-009510
Mar. 31, 2008 (JP) 2008-091438
Mar. 31, 2008 (JP) 2008-091895

(51) Int. Cl. C25F 3/16; B32B 37/00; B32B 3/10; C25F 7/00

(52) U.S. Cl. 205/640; 156/253; 204/290.01

(57) ABSTRACT

The present invention aim to provide a method of manufacturing an electropolishing pad, which is excellent in planarity, can reduce occurrence of scratches, and has a high polishing rate. The present invention relates to a method of manufacturing an electropolishing pad, including the steps of: laminating a tin sheet on and along a recessed structure surface of a resin layer to produce a laminated sheet having grooves in a tin sheet surface; and forming through holes penetrating the tin sheet and the resin layer in the laminated sheet.

### TECHNICAL FIELD

The present invention relates to a method of manufacturing an electropolishing pad (conductive sheet), which is suitably used in the process of forming a metal wiring pattern by flattening a semiconductor device including a wafer and a metal film formed thereon (electrochemical mechanical polishing: ECMP).

### BACKGROUND ART

As a representative example of a material for which high surface flatness is required, there can be mentioned a monocrystal silicon disk called a silicon wafer for manufacturing a semiconductor integrated circuit (IC or LSI). In order to form reliable semiconductor junctions of various thin films used for circuit formation in the manufacturing process of an IC or an LSI, the silicon wafer is required to be finished to have a highly precise flat surface in the steps of laminating and forming an oxide film and a metal film. In these polish finishing steps, a polishing pad is generally fixed to a rotatable support disk called a platen and a product to be processed such as a semiconductor wafer is fixed to a polishing head. A relative speed is generated between the platen and the polishing head due to the movement of the both and a polishing slurry containing abrasive grains is continuously fed onto the polishing pad to carry out the polishing operation.

The metal film for wiring is made of Al, W, Cu or the like. Recently, electrochemical mechanical polishing (ECMP) has been attracting attention as a method of polishing the metal film. The ECMP is a method in which a direct current is passed between the wafer as an anode and the platen as a cathode via an electrolyte to melt and remove the metal film on the wafer surface electrochemically.

As the polishing pad used in ECMP, for example, the following ones are proposed.

Patent Document 1 discloses a polishing pad made of a thermoplastic or thermosetting material and having grooves in a polishing surface, in which a conductive layer is formed in the grooves.

Patent Document 2 discloses a conductive polishing pad in which a conductive surface layer and a conductive pad are laminated on a front surface and a back surface of an insulating layer, respectively. The document recites, as the material of the conductive surface layer, nonmetal sheets having conductivity such as a nonwoven fabric and a woven fabric made of a conductive fiber, and nonmetal sheets impregnated with a thermosetting resin or an elastomer.

Patent Document 3 discloses a polishing pad made of an elastic material such as a urethane resin and containing conductive particles. The document recites, as the conductive particles, spherical silicon particles coated with a metal film of Au, Ag, Pt or the like.

Patent Document 4 discloses a conductive polishing pad made of a resin having conductivity, a resin in which a conductive material is dispersed, or a conductive fiber. The document recites, as the resin having conductivity, polypyrrole and polyacetylene. As to the resin in which a conductive material is dispersed, the document recites polyurethane, nylon, polyester, natural rubbers, and elastomers as the resin and carbon black, metal powders, metal oxide powders, and carbon nanotubes as the conductive material.

Patent Document 5 discloses a polishing pad for electrochemical mechanical polishing, which includes a conductive base material and a porous polymer layer having a thickness less than 1.5 mm laminated thereon.

Patent Document 6 discloses a polishing device including a fabric layer and a conductive layer disposed on the fabric layer. The document describes that the conductive layer contains a soft metal such as gold, tin, palladium, or a palladium-tin alloy.

Cu is expected to serve as a next-generation wiring material since it has advantages such as reduction in the resistance and high electromigration resistance. A Cu wiring pattern is generally formed by a damascene method, which has a problem that some portions in the wiring part are overprocessed (so-called “thinning”) in polishing the Cu film depending on the density and the dimension of the wiring pattern. Another problem of the Cu wiring pattern is that, among the problems of overprocessing of the wiring part, the central portion of the wiring part is processed fast and recessed (so-called “dishing”) mainly due to the elasticity of the polishing pad and the chemical effect of the slurry.

The thinning and the dishing can be reduced to some degree by giving high elasticity to the polishing layer. Use of a non-foamed hard polishing pad is also effective. However, use of a hard pad tends to give a scratch (damage) to a Cu film surface since the Cu film is softer than an insulating film.

As to polishing characteristics of a polishing pad for polishing a metal film, the polishing pad is required to have excellent planarity and in-plane uniformity, a small electric resistance, and a high polishing rate.

However, none of the conventional polishing pads has solved the above-mentioned problems and requirements.

Patent Document 1: Japanese Unexamined Patent Publication No. 2005-101585

Patent Document 2: Japanese Unexamined Patent Publication No. 2005-139480

Patent Document 3: Japanese Unexamined Patent Publication No. 2002-93758

Patent Document 4: Japanese Unexamined Patent Publication No. 2004-111940

Patent Document 5: Japanese Unexamined Patent Publication No. 2005-335062

Patent Document 6: Japanese Published Patent Publication No. 2006-527483

### DISCLOSURE OF THE INVENTION

### Problems to be Solved by the Invention

First and second aspects of the present invention aim to provide a method of manufacturing an electropolishing pad, which is excellent in planarity, can reduce occurrence of scratches, and has a high polishing rate. A third aspect of the present invention aims to provide a method of easily manufacturing an electropolishing pad, which is excellent in planarity and in-plane uniformity. The third aspect also aims to provide a method of manufacturing an electropolishing pad, which has a small electric resistance and a high polishing rate in addition to the above-mentioned characteristics. A fourth aspect of the present invention aims to provide a conductive sheet, which is excellent in planarity, can reduce occurrence of scratches, and has a high polishing rate.

### Means for Solving the Problems

The present inventors intensively studied to solve the above-mentioned problems and found that the following manufacturing method of an electropolishing pad or a conductive sheet can solve the above-mentioned problems and thus, they completed the present invention.

The first aspect of the present invention relates to a method of manufacturing an electropolishing pad, including the steps of: laminating a tin sheet on and along a recessed structure surface of a resin layer to produce a laminated sheet having grooves in a tin sheet surface; and forming through holes penetrating the tin sheet and the resin layer in the laminated sheet.

The laminated sheet is preferably produced by laminating an adhesive layer, the tin sheet, and a flexible sheet in this order on the recessed structure surface of the resin layer to produce a laminate, and pressing the laminate. By this method, the tin sheet can be adhered along the recessed structure of the resin layer without a gap and grooves with high surface uniformity and free of sharp edges which cause scratches can be easily formed in the tin sheet surface.

The second aspect of the present invention relates to a method of manufacturing an electropolishing pad, including the steps of: laminating a plurality of tin sheets in parallel on and along a recessed structure surface of a resin layer and burying opposed ends of the tin sheets in one recess to produce a laminated sheet having grooves in tin sheet surfaces; and forming through holes penetrating the tin sheets and the resin layer in the laminated sheet.

Electropolishing pads are expected to become larger in the future. Production of a large electropolishing pad requires a large tin sheet as a raw material, but production of a large tin sheet having high flatness is difficult. Meanwhile, use of a plurality of tin sheets bonded together is also conceivable, but scratches tend to occur when the bonded portion is low in the flatness. Additionally, since the ends of tin sheets are approximately right-angled, the ends tend to cause scratches when there is a gap in the bonded portion.

As in the second aspect of the present invention, when a plurality of tin sheets are laminated in parallel along a recessed structure of a resin layer, all the above-mentioned problems can be overcome by burying opposed ends of the tin sheets in one recess. That is, this method does not necessitate use of one large tin sheet or use of a plurality of tin sheets bonded together. Additionally, by burying the ends of the tin sheets in the recesses, it is possible to prevent occurrence of scratches since bent portions of the tin sheets are rounded.

The laminated sheet is preferably produced by laminating an adhesive layer, the tin sheets, and a flexible sheet in this order on the recessed structure surface of the resin layer and disposing the opposed ends of the tin sheets on one recess to produce a laminate, and pressing the laminate. By this method, the tin sheets can be adhered along the recessed structure of the resin layer without a gap and grooves with high surface uniformity and free of sharp edges which cause scratches can be easily formed in the tin sheet surfaces. Additionally, according to this method, the opposed ends of the tin sheets can be easily buried in one recess.

The resin layer is preferably a polyurethane layer, more preferably a polyurethane foam layer.

The hardness of the flexible sheet is preferably lower than that of the resin layer. When the hardness of the flexible sheet exceeds that of the resin layer, the flexible sheet hardly deforms into a protruded shape corresponding to the recessed structure when being pressed and therefore it becomes difficult to laminate the tin sheets along the recessed structure of the resin layer.

The thickness of the flexible sheet is preferably larger than the depth of the recess in the resin layer. When the thickness of the flexible sheet is smaller than the depth of the recess in the resin layer, the flexible sheet does not sufficiently deform into a protruded shape corresponding to the recessed structure when being pressed and therefore it becomes difficult to laminate the tin sheets along the recessed structure of the resin layer.

An electropolishing pad obtained by the manufacturing method according to the first or second aspect of the present invention has a tin sheet electrically in contact with a metal film on a wafer surface, a groove for facilitating renewal of an electrolyte and discharge of by-products generated by electropolishing, and a through hole retaining the electrolyte, which form a dense conductive network. In addition, this structure reduces the surface electric resistance of the electropolishing pad. Accordingly, the energization amount increases and the metal film on the wafer surface can be easily molten and removed electrochemically.

The resin layer is provided to protect the thin, low-strength tin sheet and is a member necessary for preventing breakage or the like of the tin sheet as well as for giving flexibility to the electropolishing pad and improving the planarity. The resin layer is a member also having a function of an insulating layer.

The tin sheet can suppress occurrence of scratches since tin is softer than Cu which is a material of a metal film for wiring.

The manufacturing method of an electropolishing pad according to the first or second aspect of the present invention preferably further includes a step of cutting the laminated sheet so as to provide at least one protrusion for anode. Accordingly, the electropolishing pad and an anode line can be integrally formed and the anode line does not fall off the electropolishing pad during the polishing operation. Additionally, since the anode line is connected to the electropolishing pad without interposing other members, the energization efficiency is improved. Furthermore, since a step of separately providing an anode line can be omitted, an electropolishing pad having an anode line can be produced simply with high productivity.

The third aspect of the present invention relates to a method of manufacturing an electropolishing pad, including the steps of: bonding a copper sheet to a pressure-sensitive adhesive layer of a pressure-sensitive adhesive tape having the pressure-sensitive adhesive layer on one surface of a release sheet to produce a pressure-sensitive adhesive copper sheet; forming grooves penetrating the copper sheet and the pressure-sensitive adhesive layer in the pressure-sensitive adhesive copper sheet to form a cathode layer having two or more copper cathode regions; bonding a polishing layer to the cathode layer; and peeling the release sheet off to expose the pressure-sensitive adhesive layer and bonding a cushion layer to the pressure-sensitive adhesive layer.

Another third aspect of the present invention relates to a method of manufacturing an electropolishing pad, including the steps of: bonding a copper sheet to a pressure-sensitive adhesive layer of a pressure-sensitive adhesive tape having the pressure-sensitive adhesive layer on one surface of a release sheet to produce a pressure-sensitive adhesive copper sheet; bonding a polishing layer to another surface of the copper sheet; forming, from the release sheet side, grooves penetrating the pressure-sensitive adhesive copper sheet to form a cathode layer having two or more copper cathode regions; and peeling the release sheet off to expose the pressure-sensitive adhesive layer and bonding a cushion layer to the pressure-sensitive adhesive layer.

Another third aspect of the present invention relates to a method of manufacturing an electropolishing pad, including the steps of: bonding a copper sheet to a doublesided tape having first and second pressure-sensitive adhesive layers on respective surfaces of a base material and a release sheet laminated on the first pressure-sensitive adhesive layer, at the second pressure-sensitive adhesive layer side, to produce a pressure-sensitive adhesive copper sheet; forming grooves penetrating the copper sheet and the second pressure-sensitive adhesive layer in the pressure-sensitive adhesive copper sheet to form a cathode layer having two or more copper cathode regions; bonding a polishing layer to the cathode layer; and peeling the release sheet off to expose the first pressure-sensitive adhesive layer and bonding a cushion layer to the first pressure-sensitive adhesive layer.

Another third aspect of the present invention relates to a method of manufacturing an electropolishing pad, including the steps of: bonding a copper sheet to a doublesided tape having first and second pressure-sensitive adhesive layers on respective surfaces of a base material and a release sheet laminated on the first pressure-sensitive adhesive layer, at the second pressure-sensitive adhesive layer side, to produce a pressure-sensitive adhesive copper sheet; bonding a polishing layer to another surface of the copper sheet; forming, from the doublesided tape side, grooves penetrating the pressure-sensitive adhesive copper sheet to form a cathode layer having two or more copper cathode regions; and peeling the release sheet off to expose the first pressure-sensitive adhesive layer and bonding a cushion layer to the first pressure-sensitive adhesive layer.

The third aspect of the present invention features that the cathode layer of the electropolishing pad is divided into two or more copper cathode regions in one plane. By zoning the cathode layer, different voltages can be applied to the copper cathode regions by different power sources. Since the metal film on the wafer surface becomes easier to remove in proportion to the energization amount, the removal rate of the metal film on the wafer surface can be regulated area by area by regulating the voltages applied to the copper cathode regions. Therefore, use of the electropolishing pad according to the present invention improves flatness and in-plane uniformity of the metal film on the wafer surface.

In ECMP, since the electropolishing pad has to follow the wafer surface at low pressure, the cathode layer has to be made of a material having low rigidity. As the cathode layer, for example, copper mesh, copper foil, nickel foil, or a composite sheet including a resin film (PET film or the like) and copper foil or nickel foil laminated thereon is used. However, since these materials are very soft and tend to wrinkle when being bent, it is difficult to bond such a cathode layer to the polishing layer or a cushion layer precisely. In particular, in zoning the cathode layer, alignment of the cathode regions is very difficult and misalignment, overlapping, bending and wrinkles easily occur, resulting in a very complicated manufacturing process. According to the manufacturing method of the present invention, it is possible to solve these problems and to form a zoned cathode layer precisely and easily.

In the manufacturing method according to the third aspect of the present invention, it is preferred to dispose an n^{th} (n is an integer of 2 or more) copper cathode region inside an n-1^{th} copper cathode region. By zoning the cathode layer into such a structure, the removal rate of the metal film on the wafer surface can be easily regulated in the wafer radius direction.

When the cathode layer is zoned into the above-mentioned structure, an n^{th} (n is an integer of 2 or more) copper cathode region preferably has a cathode line extending to an outer peripheral edge of a first copper cathode region located at the outermost part. By providing the cathode line in the n^{th} copper cathode region, the n^{th} copper cathode region located inside the n-1^{th} copper cathode region can be easily connected to a power source.

The polishing layer preferably includes at least a laminated sheet obtained by laminating a tin sheet on and along a recessed structure surface of a resin layer, and the laminated sheet preferably has grooves in the tin sheet surface and through holes penetrating the tin sheet and the resin layer.

The polishing layer has a dense conductive network formed of the tin sheet and a number of through holes retaining the electrolyte. This structure can reduce the surface electric resistance of the electropolishing pad. Accordingly, the energization amount increases and the metal film on the wafer surface can be easily molten and removed electrochemically, whereby the polishing rate increases. The resin layer is provided to protect the thin, low-strength tin sheet and is a member necessary for preventing breakage or the like of the tin sheet as well as for giving flexibility to the electropolishing pad. The resin layer is a member also having a function of an insulating layer. The tin sheet can suppress occurrence of scratches since tin is softer than Cu which is a material of a metal film for wiring.

The fourth aspect of the present invention relates to a conductive sheet including at least a laminated sheet obtained by laminating a tin sheet on and along a recessed structure surface of a resin layer, wherein the laminated sheet has grooves in the tin sheet surface and through holes penetrating the tin sheet and the resin layer.

The conductive sheet of the present invention has a tin sheet electrically in contact with a metal film on a wafer surface, a groove for facilitating renewal of an electrolyte and discharge of by-products generated by electropolishing, and a through hole retaining the electrolyte, which form a dense conductive network. In addition, this structure reduces the surface electric resistance of the conductive sheet. Accordingly, the energization amount increases and the metal film on the wafer surface can be easily molten and removed electrochemically.

The resin layer is provided to protect the thin, low-strength tin sheet and is a member necessary for preventing breakage or the like of the tin sheet as well as for giving flexibility to the conductive sheet and improving the planarity. The resin layer is a member also having a function of an insulating layer.

The tin sheet can suppress occurrence of scratches since tin is softer than Cu which is a material of a metal film for wiring.

The resin layer is preferably a polyurethane layer, more preferably a polyurethane foam layer.

The laminated sheet preferably has a protrusion for anode integrated into the laminated sheet. By integrally providing the protrusion for anode (anode line) in the laminated sheet, the anode line does not fall off the conductive sheet during the polishing operation. Additionally, since the anode line is connected to the conductive sheet without interposing other members, the energization efficiency is improved.

The present invention further relates to a method of manufacturing a semiconductor device, including the step of polishing a metal film on a semiconductor wafer surface using the conductive sheet.

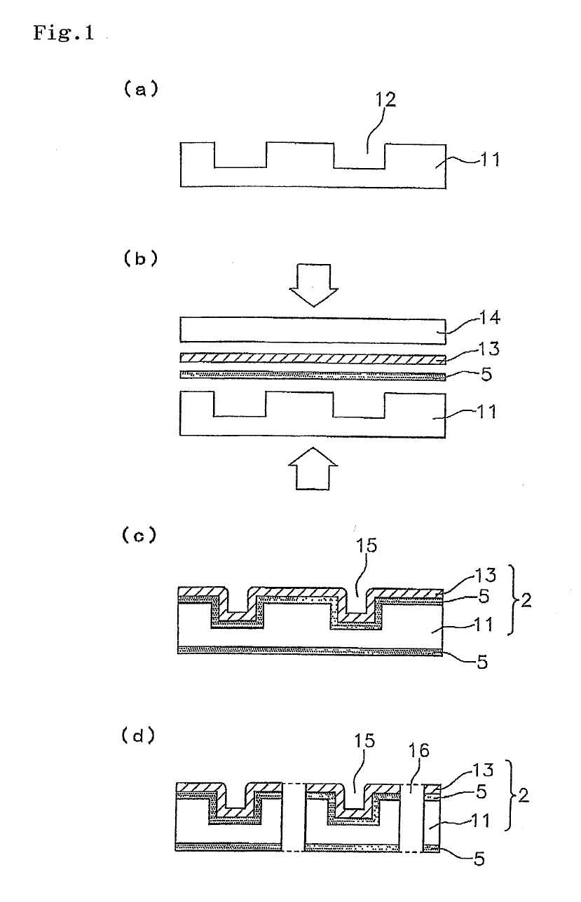

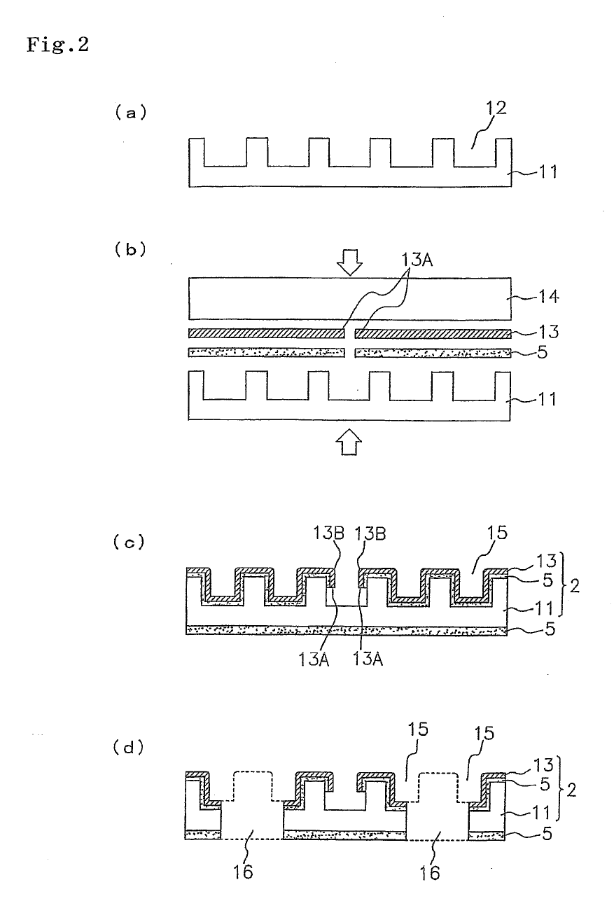

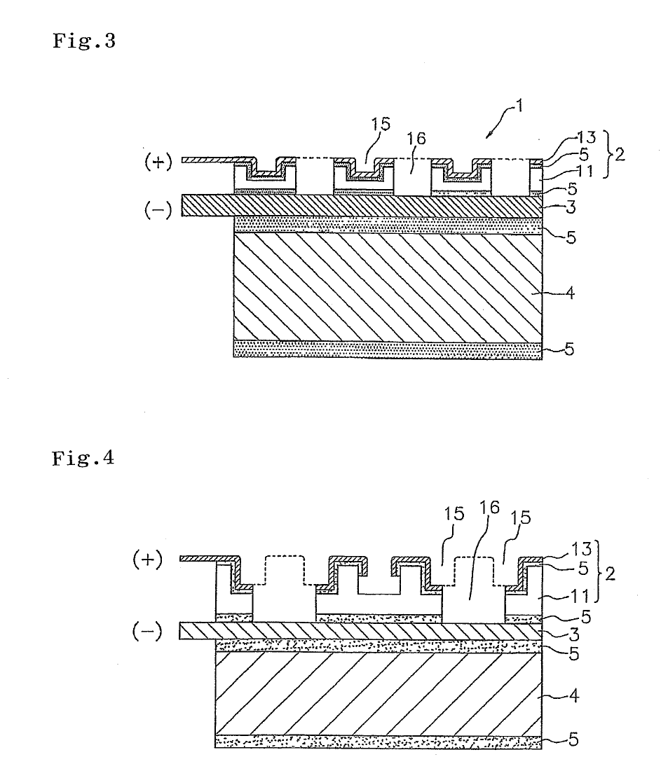

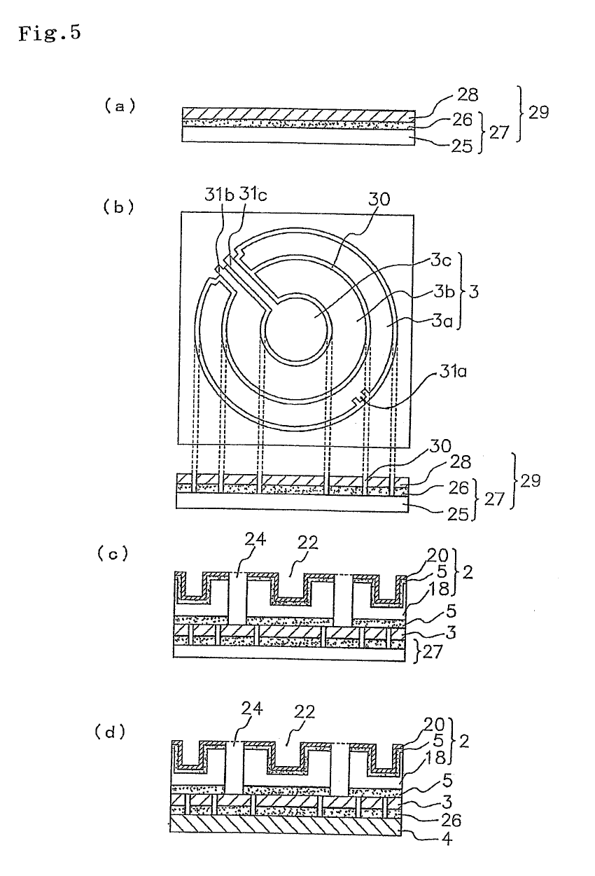

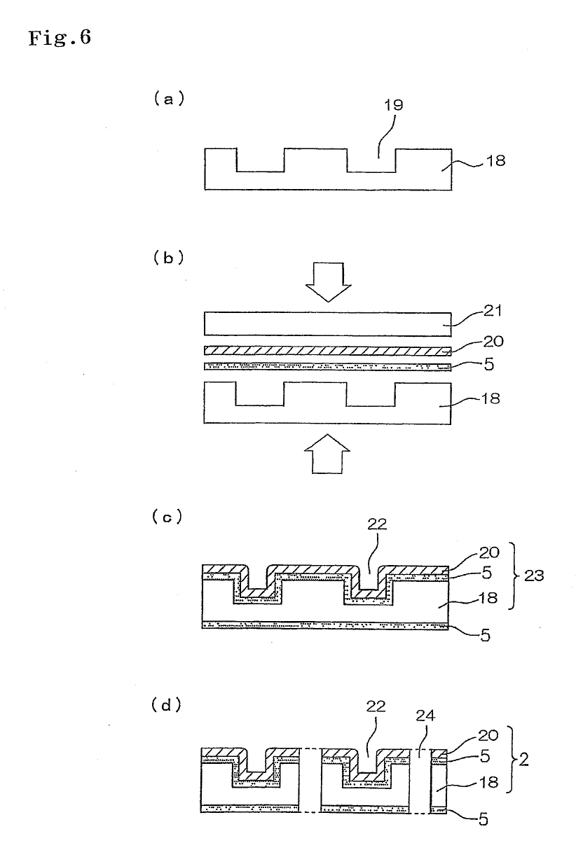

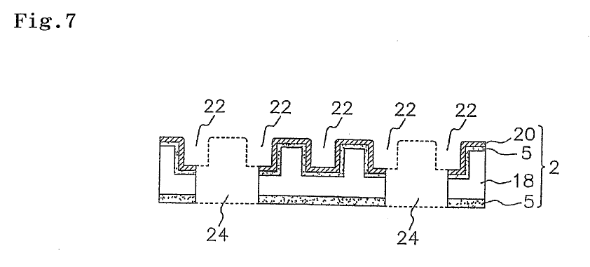

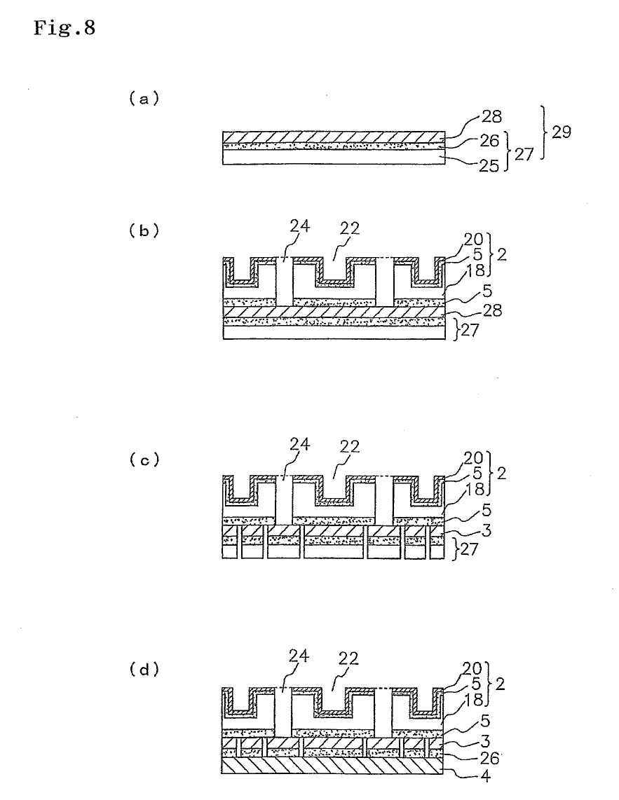

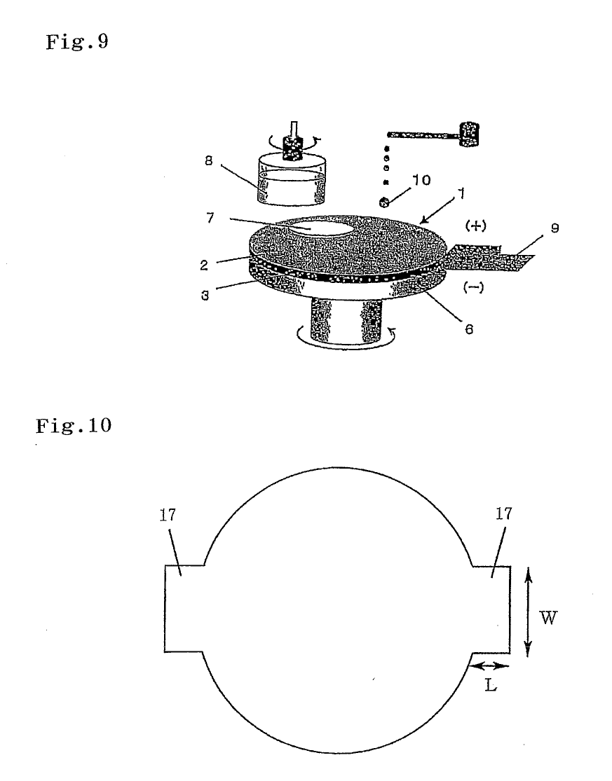

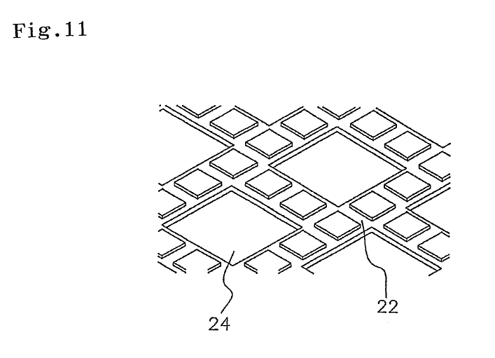

### BRIEF DESCRIPTION OF THE DRAWINGS

[FIG. 1] A schematic process chart showing an example of a manufacturing method of an electropolishing pad (conductive sheet) according to a first (fourth) aspect of the present invention.

[FIG. 2] A schematic process chart showing an example of a manufacturing method of an electropolishing pad according to a second aspect of the present invention.

[FIG. 3] A schematic cross-sectional view showing an example of an electropolishing pad (conductive sheet) according to the first (fourth) aspect of the present invention.

[FIG. 4] A schematic cross-sectional view showing an example of an electropolishing pad according to the second aspect of the present invention.

[FIG. 5] A schematic process chart showing an example of a manufacturing method of an electropolishing pad according to a third aspect of the present invention.

[FIG. 6] A schematic process chart showing an example of a manufacturing method of a polishing layer according to the third aspect of the present invention.

[FIG. 7] A schematic view showing a cross-sectional structure of the polishing layer according to the third aspect of the present invention.

[FIG. 8] A schematic process chart showing an example of the manufacturing method of the electropolishing pad according to the third aspect of the present invention.

[FIG. 9] A schematic configuration view showing an example of a polishing apparatus used in ECMP.

[FIG. 10] A schematic surface view showing an example of a laminated sheet (polishing layer) having two protrusions for anode.

[FIG. 11] A schematic view showing a surface structure of the polishing layer of Example 3-1.

### DESCRIPTION OF THE REFERENCE NUMERALS

1: electropolishing pad (conductive sheet)
2, 23: laminated sheet (polishing layer)
3: cathode layer (copper mesh)
4: cushion layer
5: adhesive layer (doublesided tape)
6: polishing plate
7: material to be polished (semiconductor wafer)
8: support (polishing head)
9: voltage application part
10: electrolyte
11, 18: polyurethane foam layer
12, 19: recess
13, 20: tin sheet
14, 21: flexible sheet
15, 22: groove
16, 24: through hole
17: protrusion for anode
25: release sheet
26: pressure-sensitive adhesive layer
27: pressure-sensitive adhesive tape
28: copper sheet
29: pressure-sensitive adhesive copper sheet
30: groove
31 (31a, 31b, 31c): cathode line

### BEST MODES FOR CARRYING OUT THE INVENTION

A method of manufacturing an electropolishing pad according to a first aspect of the present invention includes the steps of: laminating a tin sheet on and along a recessed structure surface of a resin layer to produce a laminated sheet having grooves in a tin sheet surface; and forming through holes penetrating the tin sheet and the resin layer in the laminated sheet.

A method of manufacturing an electropolishing pad according to a second aspect of the present invention includes the steps of: laminating a plurality of tin sheets in parallel on and along a recessed structure surface of a resin layer and burying opposed ends of the tin sheets in one recess to produce a laminated sheet having grooves in tin sheet surfaces; and forming through holes penetrating the tin sheets and the resin layer in the laminated sheet.

The tin sheet contains tin or a tin alloy as a raw material component. Examples of the tin alloy include a tin-copper alloy, a tin-silver alloy, a tin-nickel alloy, a tin-aluminum alloy, a tin-bismuth alloy, a tin-lead alloy, and a tin-zinc alloy. The content of tin in the alloy is preferably 80% by weight or more, more preferably 90% by weight or more, and particularly preferably 95% by weight or more.

The thickness of the tin sheet is not particularly limited, but it is preferably 50 to 1000 μm, and more preferably 100 to 500 μm. When the thickness is less than 50 μm, it is not preferred since the tin sheet tends to break during polishing due to insufficient strength. On the other hand, when the thickness exceeds 1000 μm, it is not preferred since lamination of the tin sheet along the recessed structure of the resin layer becomes difficult or the flexibility of the electropolishing pad is deteriorated.

When the size of one tin sheet is smaller than the size of the intended electropolishing pad, a plurality of tin sheets may be bonded together by an appropriate method. The size of the tin sheet is not particularly limited, but it is usually about 70 to 100 cm in length, and about 20 to 50 cm in width. Usually, two to four tin sheets are used to produce one electropolishing pad.

The resin layer has only to be made of a resin material which is capable of protecting a thin, low-strength tin sheet, gives flexibility to the electropolishing pad, and has insulation properties. Examples of the resin material include polyurethane, a polyolefin elastomer, a fluororesin, polycarbonate, and PTFE, and polyurethane is particularly preferred. Additionally, the resin layer preferably has a foam structure in order to improve the planarity. In the following, a case where the resin layer is a polyurethane foam layer will be described as a specific example.

A polyurethane foam as a material of the polyurethane foam layer is made up of an isocyanate component, a polyol component (a high-molecular-weight polyol or a low-molecular-weight polyol), and a chain extender.

As the isocyanate component, a compound known in the field of polyurethane can be used without particular limitation. The isocyanate component includes, for example, aromatic diisocyanates such as 2,4-toluene diisocyanate, 2,6-toluene diisocyanate, 2,2′-diphenyl methane diisocyanate, 2,4′-diphenyl methane diisocyanate, 4,4′-diphenyl methane diisocyanate, polymeric MDI, carbodiimide-modified MDI (for example, Millionate MTL made by Nippon Polyurethane Industry Co., Ltd.), 1,5-naphthalene diisocyanate, p-phenylene diisocyanate, m-phenylene diisocyanate, p-xylylene diisocyanate and m-xylylene diisocyanate, aliphatic diisocyanates such as ethylene diisocyanate, 2,2,4-trimethyl hexamethylene diisocyanate and 1,6-hexamethylene diisocyanate, and cycloaliphatic diisocyanates such as 1,4-cyclohexane diisocyanate, 4,4′-dicyclohexyl methane diisocyanate, isophorone diisocyanate and norbornane diisocyanate. These may be used alone or as a mixture of two or more thereof.

The high-molecular-weight polyol includes, for example, polyether polyols represented by polytetramethylene ether glycol, polyester polyols represented by polybutylene adipate, polyester polycarbonate polyols exemplified by reaction products of polyester glycols such as polycaprolactone polyol and polycaprolactone with alkylene carbonate, polyester polycarbonate polyols obtained by reacting ethylene carbonate with a multivalent alcohol and reacting the resulting reaction mixture with an organic dicarboxylic acid, and polycarbonate polyols obtained by ester exchange reaction of a polyhydroxyl compound with aryl carbonate. These may be used singly or as a mixture of two or more thereof.

Besides the above high-molecular-weight polyol described in the above as a polyol component, it is preferred to concomitantly use a low-molecular-weight polyol such as ethyleneglycol, 1,2-propylene glycol, 1,3-propylene glycol, 1,4-butanediol, 1,6-hexanediol, neopentylglyol, 1,4-cyclohexanedimethanol, 3-methyl-1,5-pentanediol, diethyleneglycol, triethyleneglycol, 1,4-bis(2-hydroxyethoxy)benzene, trimethylolpropane, glycerin, 1,2,6-hexanetriol, pentaerythritol, tetramethylol cyclohexane, methylglucoside, sorbitol, mannitol, dulcitol, sucrose, 2,2,6,6-tetrakis(hydroxymethyl)cyclohexanol, and triethanol amine. Low-molecular-weight polyamine such as ethylenediamine, tolylenediamine, diphenylmethanediamine, and diethylenetriamine may be used. These may be used singly or in combination of two or more kinds.

In the case where a polyurethane foam is produced by means of a prepolymer method, a chain extender is used in curing of a prepolymer. A chain extender is an organic compound having at least two active hydrogen groups and examples of the active hydrogen group include: a hydroxyl group, a primary or secondary amino group, a thiol group (SH) and the like. Concrete examples of the chain extender include: polyamines such as 4,4′-methylenebis(o-chloroaniline)(MOCA), 2,6-dichloro-p-phenylenediamine, 4,4′-methylenebis(2,3-dichloroaniline), 3,5-bis(methylthio)-2,4-toluenediamine, 3,5-bis(methylthio)-2,6-toluenediamine, 3,5-diethyltoluene-2,4-diamine, 3,5-diethyltoluene-2,6-diamine, trimethylene glycol-di-p-aminobenzoate, polytetramethylene oxide-di-p-aminobenzoate, 4,4′-diamino-3,3′,5,5′-tetraethyldiphenylmethane, 4,4′-diamino-3,3′-diisopropyl-5,5′-dimethyldiphenylmethane, 4,4′-diamino-3,3′,5,5′-tetraisopropyldiphenylmethane, 1,2-bis(2-aminophenylthio)ethane, 4,4′-diamino-3,3′-diethyl-5,5′-dimethyldiphenylmethane, N,N′-di-sec-butyl-4,4′-diaminophenylmethane, 3,3′-diethyl-4,4′-diaminodiphenylmethane, m-xylylenediamine, N,N′-di-sec-butyl-p-phenylenediamine, m-phenylenediamine and p-xylylenediamine; low-molecular-weight polyol; and a low-molecular-weight polyamine. The chain extenders described above may be used either alone or in mixture of two kinds or more.

A polyurethane foam can be produced by applying a melting method, a solution method or a known urethanization technique, among which preferable is a melting method, consideration being given to a cost, a working environment and the like.

Manufacture of a polyurethane foam is enabled by means of either a prepolymer method or a one shot method, of which preferable is a prepolymer method in which an isocyanate-terminated prepolymer is synthesized from an isocyanate component and a polyol component in advance, with which a chain extender is reacted since physical properties of an obtained polyurethane resin is excellent.

Manufacture of the polyurethane foam is to mix the first component containing an isocyanate group containing compound and the second component containing an active hydrogen group containing compound to thereby cure the reaction product. In the prepolymer method, an isocyanate-terminated prepolymer serves as an isocyanate group containing compound and a chain extender serves as an active hydrogen group containing compound. In the one shot method, an isocyanate component serves as an isocyanate group containing compound, and a chain extender and a polyol component combined serves as an active hydrogen containing compound.

Manufacturing methods of a polyurethane foam include: a method in which hollow beads are added, a mechanically foaming method, a chemically forming method and the like.

The mechanically foaming method using a silicone-based surfactant consisting of a polyalkyl siloxane/polyether copolymer is preferable. As the silicone-based surfactant, SH-192 and L-5340 (Toray Dow Corning Silicone Co., Ltd.) can be mentioned as a preferable compound.

Various additives may be mixed; such as a stabilizer including an antioxidant, a lubricant, a pigment, a filler, an antistatic agent and others.

Description will be given of an example of a method of producing a polyurethane foam of a fine cell type below. A method of manufacturing such a polyurethane foam has the following steps:

1) a foaming step of preparing a cell dispersion liquid of an isocyanate-terminated prepolymer (a first component), wherein a silicone-based surfactant is added into an isocyanate-terminated prepolymer, which is agitated in the presence of a non-reactive gas to thereby disperse the non-reactive gas into the prepolymer as fine cells and obtain a cell dispersion liquid. In a case where the prepolymer is solid at an ordinary temperature, the prepolymer is preheated to a proper temperature and used in a molten state.
2) a curing agent (chain extender) mixing step,
wherein a chain extender (a second component) is added into the cell dispersion liquid, which is agitated to thereby obtain a foaming reaction liquid.
3) a casting step,
wherein the forming reaction liquid is cast into a mold.
4) a curing step,
wherein the foaming reaction liquid having been cast into the mold is heated and reaction-cured.

The non-reactive gas used for forming fine cells is preferably not combustible, and is specifically nitrogen, oxygen, a carbon dioxide gas, a rare gas such as helium and argon, and a mixed gas thereof, and the air dried to remove water is most preferable in respect of cost.

As a stirrer for dispersing the silicone-based surfactant-containing first component to form fine cells with the non-reactive gas, known stirrers can be used without particular limitation, and examples thereof include a homogenizer, a dissolver, a twin-screw planetary mixer etc. The shape of a stirring blade of the stirrer is not particularly limited either, but a whipper-type stirring blade is preferably used to form fine cells.

In a preferable mode, different stirrers are used in stirring for forming a cell dispersion liquid in the stirring step and in stirring for mixing an added chain extender in the mixing step, respectively. In particular, stirring in the mixing step may not be stirring for forming cells, and a stirrer not generating large cells is preferably used. Such a stirrer is preferably a planetary mixer. The same stirrer may be used in the stirring step and the mixing step, and stirring conditions such as revolution rate of the stirring blade are preferably regulated as necessary.

In the method of producing the polyurethane foam, heating and post-curing of the foam obtained after casting and reacting the forming reaction liquid in a mold until the dispersion lost fluidity are effective in improving the physical properties of the foam, and are extremely preferable. The forming reaction liquid may be cast in a mold and immediately post-cured in a heating oven, and even under such conditions, heat is not immediately conducted to the reactive components, and thus the diameters of cells are not increased. The curing reaction is conducted preferably at normal pressures to stabilize the shape of cells.

In the production of the polyurethane foam, a known catalyst promoting polyurethane reaction, such as tertiary amine-based catalysts, may be used. The type and amount of the catalyst added are determined in consideration of flow time in casting in a predetermined mold after the mixing step.

Production of the polyurethane foam may be in a batch system where each component is weighed out, introduced into a vessel and mixed or in a continuous production system where each component and a non-reactive gas are continuously supplied to, and stirred in, a stirring apparatus and the resulting forming reaction liquid is transferred to produce molded articles.

A prepolymer which is a raw material from which a polyurethane foam is made is put into a reaction vessel, thereafter a chain extender is mixed into the prepolymer, the mixture is agitated, thereafter the mixture is cast into a mold with a predetermined size to thereby prepare a block and the block is sliced with a slicer like a planer or a band saw; and in another of which in the step of casting into the mold, a thin sheet may be directly produced. Besides, a still another way may be adopted in which a resin of raw material is melted, the melt is extruded through a T die to thereby mold a polyurethane foam directly in the shape of a sheet.

An average cell diameter of a polyurethane foam is preferably 30 to 80 μm and more preferably 30 to 60 μm.

The specific gravity of the polyurethane foam is preferably 0.5 to 1.3. When the specific gravity is less than 0.5, the tin sheet tends to break during electropolishing due to insufficient strength or the electropolishing pad tends to be deteriorated in the planarity. On the other hand, when the specific gravity exceeds 1.3, the electropolishing pad tends to be deteriorated in the planarity due to low flexibility.

The hardness of the polyurethane foam is not particularly limited, but it is preferably 65 degrees or less as measured by an Asker D hardness meter. When the Asker D hardness exceeds 65 degrees, the electropolishing pad tends to be deteriorated in the planarity due to low flexibility or scratches tend to occur.

The thickness of the polyurethane foam layer is not particularly limited, but it is usually 0.3 to 3 mm and preferably 0.5 to 2 mm from the viewpoints of flexibility and strength.

A manufacturing method of an electropolishing pad according to the first aspect of the present invention will be described with reference to FIG. 1. The electropolishing pad according to the first aspect of the present invention may be a laminated sheet alone or a laminate of the laminated sheet and other layers (for example, an adhesive layer, a cathode layer, a cushion layer, an insulating layer, and a conductive layer).

Step (a) is a step of forming recesses 12 in a polyurethane foam layer 11. The recesses 12 are not particularly limited as long as they have a shape which allows renewal of an electrolyte and discharge of by-products by an electrochemical reaction. Examples of the recessed structure include an XY lattice, a concentric circle, a polygonal column, a cylinder, a helix, an eccentric circle, a radial form, and combinations thereof. Although the recessed structure generally has regularity, it is also possible to vary the pitch, width, depth and the like of the recesses at every certain range in order to achieve desirable renewability of the electrolyte and dischargeability of by-products. More specifically, it is preferred that the pitch of the recesses be 1 to 30 mm, the width be 0.1 to 15 mm, and the depth be 0.05 to 1 mm.

The method of forming the recesses 12 is not particularly limited, and examples thereof include a method of mechanically cutting the polyurethane foam layer using a jig such as a turning tool of a predetermined size, a method of casting a thermosetting polyurethane resin into a mold having a predetermined surface shape and curing the resin, a method of pressing a polyurethane resin with a pressing plate having a predetermined surface shape, and a method by use of laser light using carbon dioxide gas laser or the like.

Step (b) is a step of laminating a tin sheet 13 on and along a recessed structure surface of the polyurethane foam layer 11 having the recesses 12 to produce a laminated sheet 2 having grooves 15 in a tin sheet surface. The method of laminating the tin sheet 13 on the polyurethane foam layer 11 along the recessed structure is not particularly limited. For example, there can be mentioned (1) a method of laminating the tin sheet 13, an adhesive layer (doublesided tape) 5, and the polyurethane foam layer 11 in this order and thereafter pressing the laminate from above the tin sheet 13 using a pressing plate or roll having a protruded structure surface; and (2) a method of laminating a flexible sheet 14, the tin sheet 13, the adhesive layer (doublesided tape) 5, and the polyurethane foam layer 11 in this order and thereafter pressing the laminate. The method (2) is particularly preferred because of being capable of adhering the tin sheet 13 along the recessed structure of the polyurethane foam layer 11 and of easily forming the grooves 15 high in surface uniformity and free of sharp edges which cause scratches.

The flexible sheet 14 is a member necessary for laminating the tin sheet 13 along the recessed structure. More specifically, since the flexible sheet 14 easily deforms into a protruded shape corresponding to the recessed structure of the polyurethane foam layer 11 by pressing, it is possible to adhere the tin sheet 13 sandwiched between the flexible sheet 14 and the polyurethane foam layer 11 to the polyurethane foam layer 11 while being conformed with the recessed structure.

Examples of the material of the flexible sheet 14 include a rubber, a thermoplastic elastomer, and a polymer resin foam.

Examples of the rubber include a natural rubber, a silicone rubber, an acrylic rubber, a urethane rubber, a butadiene rubber, a chloroprene rubber, an isoprene rubber, a nitrile rubber, an epichlorohydrin rubber, a butyl rubber, a fluororubber, an acrylonitrile-butadiene rubber, an ethylene-propylene rubber, and a styrene-butadiene rubber.

Examples of the thermoplastic elastomer (TPE) include a natural rubber TPE, a polyurethane TPE, a polyester TPE, a polyamide TPE, a fluorine TPE, a polyolefin TPE, a polyvinyl chloride TPE, a styrene TPE, a styrene-butadiene-styrene block copolymer (SBS), a styrene-ethylene-butylene-styrene block copolymer (SEBS), a styrene-ethylene-propylene-styrene block copolymer (SEPS), and a styrene-isoprene-styrene block copolymer (SIS).

Examples of the polymer resin foam include a polyethylene foam and a polyurethane foam.

The hardness of the flexible sheet 14 needs to be lower than that of the polyurethane foam layer 11 and more specifically, it is preferably 80 degrees or less as measured by an Asker C hardness meter. When the Asker C hardness exceeds 80 degrees, the flexible sheet 14 hardly deforms into a protruded shape corresponding to the recessed structure when being pressed and therefore it becomes difficult to laminate the tin sheet 13 along the recessed structure of the polyurethane foam layer 11.

The thickness of the flexible sheet 14 needs to be larger than the depth of the recess 12. When the thickness of the flexible sheet 14 is smaller than the depth of the recess 12, the flexible sheet 14 does not adequately deforms into a protruded shape corresponding to the recessed structure when being pressed and therefore it becomes difficult to laminate the tin sheet 13 along the recessed structure of the polyurethane foam layer 11 without a gap.

A general material may be used for the adhesive layer (doublesided tape) 5. Examples of the material include a rubber adhesive, an acrylic adhesive, and a hot-melt adhesive.

As a means for pressing, for example, a pressing plate and a roll can be mentioned. The pressure in pressing and the pressing time are not particularly limited as long as the tin sheet 13 can be laminated along the recessed structure of the polyurethane foam layer 11. The pressure is about 0.5 to 20 MPa, preferably 1 to 15 MPa, and the pressing time is about 0.1 to 120 seconds, preferably 1 to 30 seconds. When the adhesive layer 5 is made of a hot-melt adhesive, the laminate is pressed using a heated pressing plate or the like.

The groove 15 in the tin sheet surface preferably has a width of 0.1 to 15 mm and a depth of 0.05 to 1 mm.

Step (c) is a step of providing an adhesive layer (doublesided tape) 5 on one surface of the polyurethane foam layer 11. The adhesive layer 5 is provided in order to bond the laminated sheet 2 to a cathode layer. The adhesive layer 5 may be provided after forming through holes 16 in the laminated sheet 2, but it is preferred to provide the adhesive layer 5 before forming the through holes 16 in view of the manufacturing process.

Step (d) is a step of forming the plurality of through holes 16 penetrating the tin sheet and the polyurethane foam layer in portions other than the grooves 15 in the laminated sheet 2.

As the method of forming the through holes 16, for example, a method of punching the through holes 16 with a Thomson pressing machine or a male-female pressing machine and a processing method using a water cutter or laser can be mentioned. When an electropolishing pad is to be produced by laminating the laminated sheet 2, the cathode layer and the adhesive layer 5, the through holes 16 have to be provided not only in the laminated sheet 2 but also in the adhesive layer 5 in order to pass a direct current between the laminated sheet 2 as the anode and the cathode layer via an electrolyte.

The surface shape of the through hole 16 is not particularly limited and for example, a circle, an ellipse, a tetragon, and a polygon can be mentioned, but it is preferably a circle. When the surface shape of the through hole 16 is a circle, the diameter thereof is about 1 to 50 mm. The groove 15 and the through hole 16 may be interlocked.

The cross-sectional shape of the through hole 16 is not particularly limited and for example, a square, a rectangle, and a trapezoid can be mentioned.

The total surface area of the through holes 16 is preferably 5 to 80%, and more preferably 10 to 60% of the surface area of the laminated sheet 2. When the total surface area of the through holes 16 is less than 5%, the polishing rate decreases due to insufficient provision of the electrolyte, whereas when it exceeds 80%, the electropolishing pad tends to be deteriorated in the mechanical strength, or deteriorated in the planarity due to an increase in the polishing rate.

The thickness variation of the laminated sheet 2 is preferably 100 μm or less. When the thickness variation exceeds 100 μm, the electropolishing pad has large undulation to have portions different in the state of contact with a metal film, which gives an adverse influence on the polishing characteristics. In order to deny the thickness variation of the electropolishing pad, a surface of the electropolishing pad is generally subjected to dressing using a dresser on which diamond abrasive grains are electrodeposited or fused in an early stage of polishing. The laminated sheet 2 with the thickness variation exceeding the above-mentioned range has a long dressing time and is low in the production efficiency.

As the method of suppressing the thickness variation of the laminated sheet 2, a method of buffing a surface of the tin sheet 13 can be mentioned. The buffing is preferably carried out gradually using polishing materials different in the particle size or the like.

The surface electric resistance of the laminated sheet 2 is preferably 1.0×10⁻¹Ω or less, and more preferably 5.0×10⁻²Ω or less. When the surface electric resistance is high, it is not preferred since heat may be generated during electropolishing.

The laminated sheet 2 may have an elongated shape of several meters, or may be a circle of about 7 to 90 cm.

In any of the steps after the production of the laminated sheet 2, the laminated sheet 2 may be cut so as to provide at least one protrusion for anode. The length and the width of the protrusion for anode are not particularly limited, but the length is about 20 to 40 mm and the width is about 50 to 120 mm.

In the following, a manufacturing method of an electropolishing pad according to the second aspect of the present invention will be described with reference to FIG. 2. However, descriptions overlapping the manufacturing method of an electropolishing pad according to the first aspect of the present invention will be omitted.

Step (a) is similar to that in the first aspect of the present invention.

Step (b) is a step of laminating a plurality of tin sheets 13 in parallel on and along a recessed structure surface of the polyurethane foam layer 11 having the recesses 12 and burying opposed ends 13A of the tin sheets in one of the recesses 12 to produce a laminated sheet 2 having grooves 15 in tin sheet surfaces. The method of laminating the tin sheets 13 on the polyurethane foam layer 11 along the recessed structure is not particularly limited. For example, there can be mentioned (1) a method of laminating the tin sheets 13, adhesive layers (doublesided tapes) 5, and the polyurethane foam layer 11 in this order and thereafter pressing the laminate from above the tin sheets 13 using a pressing plate or roll having a protruded structure surface; and (2) a method of laminating a flexible sheet 14, the tin sheets 13, the adhesive layers (doublesided tapes) 5, and the polyurethane foam layer 11 in this order and thereafter pressing the laminate. The method (2) is particularly preferred because of being capable of adhering the tin sheets 13 along the recessed structure of the polyurethane foam layer 11 and of easily forming the grooves 15 high in surface uniformity and free of sharp edges which cause scratches. Each of the adhesive layers (doublesided tapes) 5 may be bonded to one surface of each of the tin sheets 13 beforehand.

When the plurality of tin sheets 13 are laminated in parallel along a recessed structure of the polyurethane foam layer 11, the opposed ends 13A of the tin sheets are preferably disposed on one of the recesses 12. By this disposition, the opposed ends 13A of the tin sheets can be buried in the recess 12 by the subsequent pressing. Since bent portions 13B of the tin sheets are rounded by burying the opposed ends 13A of the tin sheets in the recess 12, occurrence of scratches can be prevented. When the opposed ends 13A of the tin sheets are disposed on the recess 12, the ends 13A of the tin sheets may be disposed at a predetermined interval as shown in FIG. 2(b), or may be disposed so that the opposed ends 13A of the tin sheets may slightly overlap each other. As to the adhesive layer (doublesided tape) 5, a plurality of layers each corresponding to the size of each tin sheet or one large layer may be used.

The flexible sheet 14 is a member necessary for laminating the tin sheets 13 along the recessed structure and for burying the ends 13A of the tin sheets in the recesses 12. More specifically, since the flexible sheet 14 easily deforms into a protruded shape corresponding to the recessed structure of the polyurethane foam layer 11 by pressing, it is possible to adhere the tin sheets 13 sandwiched between the flexible sheet 14 and the polyurethane foam layer 11 to the polyurethane foam layer 11 while being conformed with the recessed structure and to bury the ends 13A of the tin sheets in the recesses 12.

Step (c) is similar to that in the first aspect of the present invention.

Step (d) is a step of forming a plurality of through holes 16 penetrating the tin sheets and the polyurethane foam layer in the laminated sheet 2. The through holes 16 may be formed in portions other than the grooves 15, in the grooves 15, or so as to connect one of the grooves 15 with another one, but in order to suppress scratches, they are preferably formed in the grooves 15 or so as to connect one of the grooves 15 with another one.

As shown in FIGS. 3 and 4, an electropolishing pad 1 according to the first or second aspect of the present invention may be one obtained by bonding the laminated sheet 2, a cathode layer 3 and a cushion layer 4 together. An anode line is usually provided on the laminated sheet 2. The anode line may be separately provided after or during formation of the laminated sheet 2, or may be integrally formed with part of the laminated sheet 2 as its formation material.

A publicly known material may be used for the cathode layer 3 without any particular limitation. Examples thereof include copper mesh, copper foil, nickel foil, a composite sheet including a resin film (PET film or the like) and copper foil or nickel foil laminated thereon, and a composite sheet obtained by depositing copper or nickel on a resin film (PET film or the like). As the material of the cathode layer 3, one that is free of metallic contamination is appropriately selected in view of the metal film on the wafer surface. When the metal film on the wafer surface is made of copper, copper is used as the material of the cathode layer 3. Copper mesh is preferably used from the viewpoints of flexibility and bendability.

The cushion layer 4 serves to compensate for the characteristics of the electropolishing pad. The cushion layer is necessary for achieving both of the planarity and uniformity, which are in a trade-off relationship in ECMP. The planarity is improved by the characteristics of the electropolishing pad and the uniformity is improved by the characteristics of the cushion layer. In the electropolishing pad of the present invention, the cushion layer to be used is preferably softer than the electropolishing pad.

As the material of the cushion layer, fiber nonwoven fabrics such as a polyester nonwoven fabric, a nylon nonwoven fabric and an acrylic nonwoven fabric, resin-impregnated nonwoven fabrics such as a polyester nonwoven fabric impregnated with polyurethane, polymer resin foams such as a polyurethane foam and a polyethylene foam, rubbery resins such as a butadiene rubber and an isoprene rubber, and photosensitive resins can be mentioned.

As a means for bonding the laminated sheet 2, the cathode layer 3 and the cushion layer 4 together, for example, a method of pressing them while sandwiching them in between the adhesive layers (doublesided tapes) 5 and a method using a hot-melt adhesive can be mentioned.

The electropolishing pad 1 may have the adhesive layer (for example, a doublesided tape) 5 on a surface in contact with a platen. When the electropolishing pad 1 is fixed onto a magnetic platen by the magnetic force of the platen, the surface in contact with the platen may be provided with a magnetic layer (for example, a magnetic SUS layer).

In the following, a manufacturing method of an electropolishing pad according to the third aspect of the present invention will be described with reference to FIG. 5. However, descriptions overlapping the manufacturing method of an electropolishing pad according to the first aspect of the present invention will be omitted.

Step (a) is a step of bonding a copper sheet 28 to a pressure-sensitive adhesive layer 26 of a pressure-sensitive adhesive tape 27 having the pressure-sensitive adhesive layer 26 on one surface of a release sheet 25 to produce a pressure-sensitive adhesive copper sheet 29.

The pressure-sensitive adhesive tape 27 is not particularly limited and a general tape may be used. Examples of the material of the release sheet 25 include polyethylene terephthalate, polyester, polyethylene, polypropylene, polystyrene, polyimide, polyvinyl alcohol, polyvinyl chloride, fluorine-containing resins such as polyfluoroethylene, nylon, cellulose and paper. The composition of the pressure-sensitive adhesive layer 26 may include a rubber pressure-sensitive adhesive or an acrylic pressure-sensitive adhesive.

The copper sheet 28 is a formation material of a cathode layer 3. Examples thereof include copper mesh, copper foil, a composite sheet including a resin film (PET film or the like) and copper foil laminated thereon, and a composite sheet obtained by depositing copper on a resin film (PET film or the like). Copper mesh is preferably used from the viewpoints of flexibility and bendability. The thickness of the copper sheet is not particularly limited, but it is generally about 20 to 1000 μm and preferably 25 to 500 μm from the viewpoints of flexibility and bendability.

A doublesided tape having pressure-sensitive adhesive layers on both surfaces of a base material and a release sheet laminated on one of the pressure-sensitive adhesive layers may be used instead of the pressure-sensitive adhesive tape 27. Examples of the material of the base material include polyethylene terephthalate, polyester, polyethylene, polypropylene, polystyrene, polyimide, polyvinyl alcohol, polyvinyl chloride, fluorine-containing resins such as polyfluoroethylene, nylon and cellulose.

Step (b) is a step of forming grooves 30 penetrating the copper sheet 28 and the pressure-sensitive adhesive layer 26 in the pressure-sensitive adhesive copper sheet 29 to form a cathode layer 3 having a first copper cathode region 3a, a second copper cathode region 3b and a third copper cathode region 3c. FIG. 5(b) is a schematic view showing a surface and a cross-section of the pressure-sensitive adhesive copper sheet 29 in which the grooves 30 are formed. In this step, the pressure-sensitive adhesive copper sheet 29 may be punched at the outer peripheral edge of the first copper cathode region 3a into a circular shape.

The grooves 30 have only to penetrate the copper sheet 28 and the pressure-sensitive adhesive layer 26 and should not penetrate the release sheet 25. Similarly, when a doublesided tape is used, the grooves 30 have only to penetrate the copper sheet and the pressure-sensitive adhesive layer and should not penetrate the release sheet. As the method of forming the grooves 30, for example, a method of cutting the grooves 30 with a Thomson pressing machine and a processing method using a water cutter or laser can be mentioned, but the method is not limited thereto.

The width of the groove 30 is not particularly limited as long as the adjacent copper cathode regions do not contact with each other, but it is usually about 1 to 2 mm and preferably 1 to 1.5 mm.

Two or more copper cathode regions have to be formed in the pressure-sensitive adhesive copper sheet. The number of the copper cathode regions can be appropriately changed in relation to the polishing apparatus used, but it is usually two to five.

The shape and the manner of disposition of the copper cathode regions are not particularly limited, but it is preferred to dispose an n^{th} (n is an integer of 2 or more) copper cathode region inside an n-1^{th} copper cathode region. More specifically, as shown in FIG. 5(b), it is preferred to form the second copper cathode region 3b inside the first copper cathode region 3a and form the third copper cathode region 3c inside the second copper cathode region 3b to form the cathode layer 3 zoned into a concentric circle structure. Additionally, the copper cathode regions are preferably in a balanced ring or circular shape.

The n^{th} (n is an integer of 2 or more) copper cathode region preferably has a cathode line 31 extending to the outer peripheral edge of the first copper cathode region 3a. More specifically, as shown in FIG. 5(b), the second copper cathode region 3b and the third copper cathode region 3c preferably have cathode lines 31b and 31c which extend to the outer peripheral edge of the first copper cathode region 3a, respectively. Provision of the cathode lines 31b and 31c facilitates connection of the second copper cathode region 3b and the third copper cathode region 3c inside the first copper cathode region 3a to a power source.

Step (c) is a step of bonding a polishing layer 2 to the cathode layer 3. When laminating the polishing layer 2 and the cathode layer 3 using a pressure-sensitive adhesive layer 5, through holes have to be provided not only in the polishing layer 2 but also in the pressure-sensitive adhesive layer 5 in order to pass a direct current between the polishing layer 2 as the anode and the cathode layer 3 via an electrolyte.

As to the polishing layer, any layer used as a polishing layer of an electropolishing pad can be used without particular limitation. It is preferred to use a polishing layer including at least a laminated sheet obtained by laminating a tin sheet on and along a recessed structure surface of a resin layer, wherein the laminated sheet has grooves in the tin sheet surface and a number of through holes penetrating the tin sheet and the resin layer.

The polishing layer can be manufactured by a method similar to the manufacturing method of the laminated sheet of the first aspect of the present invention (see FIG. 6).

However, through holes 24 may be formed in portions other than grooves 22 as shown in FIG. 6(d), or may be formed in the grooves 22. The through holes 24 are preferably formed so as to connect one of the grooves 22 with another one, as shown in FIG. 7. As shown in FIG. 7, occurrence of scratches due to burr or edge crack can be effectively prevented by locating the cutting surfaces of the through holes below the polishing surface.

The polishing layer is preferably a circle of about 7 to 90 cm. The thickness of the polishing layer is about 0.3 to 5 mm. The polishing surface of the polishing layer may be subjected to embossing or groove processing. An anode line is usually provided on the polishing layer. The anode line may be separately provided after or during formation of the polishing layer, or may be integrally formed with part of the polishing layer as its formation material.

In the following, descriptions will be made with reference to FIG. 5(d) returning to the manufacturing method of an electropolishing pad according to the third aspect of the present invention.

Step (d) is a step of peeling the release sheet 25 off to expose the pressure-sensitive adhesive layer 26 and bonding a cushion layer 4 to the pressure-sensitive adhesive layer 26. When a doublesided tape is used instead of the pressure-sensitive adhesive tape 11, the release sheet is peeled off to expose the pressure-sensitive adhesive layer and the cushion layer 4 is bonded to the pressure-sensitive adhesive layer. As the cushion layer 4, layers similar to those mentioned above can be used.

In the following, another manufacturing method of an electropolishing pad according to the third aspect of the present invention will be described with reference to FIG. 8. However, descriptions overlapping the above-mentioned manufacturing method of an electropolishing pad will be omitted.

Step (a) is a step of bonding a copper sheet 28 to a pressure-sensitive adhesive layer 26 of a pressure-sensitive adhesive tape 27 having the pressure-sensitive adhesive layer 26 on one surface of a release sheet 25 to produce a pressure-sensitive adhesive copper sheet 29. A doublesided tape having pressure-sensitive adhesive layers on both surfaces of a base material and a release sheet laminated on one of the pressure-sensitive adhesive layers may be used instead of the pressure-sensitive adhesive tape 27.

Step (b) is a step of bonding a polishing layer 2 to another surface of the copper sheet 28.

Step (c) is a step of forming, from the release sheet 25 side, grooves 30 penetrating the pressure-sensitive adhesive copper sheet 29 to form a cathode layer 3 having two or more copper cathode regions. More specifically, step (c) is a step of forming, from the release sheet 25 side, the grooves 30 penetrating the pressure-sensitive adhesive copper sheet 29 to form a cathode layer 3 having a first copper cathode region 3a, a second copper cathode region 3b and a third copper cathode region 3c as shown in FIG. 5(b). In this step, the pressure-sensitive adhesive copper sheet and the polishing layer may be punched at the outer peripheral edge of the first copper cathode region into a circular shape.

Step (d) is a step of peeling the release sheet 25 off to expose the pressure-sensitive adhesive layer 26 and bonding a cushion layer 4 to the pressure-sensitive adhesive layer 26. When a doublesided tape is used instead of the pressure-sensitive adhesive tape 11, the release sheet is peeled off to expose the pressure-sensitive adhesive layer and the cushion layer 4 is bonded to the pressure-sensitive adhesive layer.

In the manufacturing method of the electropolishing pad according to the third aspect of the present invention, a pressure-sensitive adhesive layer (for example, a doublesided tape) may be provided on a surface of the cushion layer in contact with a platen. When the electropolishing pad is fixed onto a magnetic platen by the magnetic force of the platen, the surface of the cushion layer in contact with the platen may be provided with a magnetic layer (for example, a magnetic SUS layer).

A conductive sheet according to the fourth aspect of the present invention includes at least a laminated sheet obtained by laminating a tin sheet on and along a recessed structure surface of a resin layer. The laminated sheet has grooves in the tin sheet surface and through holes penetrating the tin sheet and the resin layer. Since the conductive sheet can be manufactured by a method similar to the manufacturing method of the electropolishing pad according to the first aspect of the present invention, specific descriptions of the manufacturing method will be omitted.

FIG. 9 is a schematic configuration view showing an example of a polishing apparatus used in ECMP. In ECMP, an electropolishing pad (conductive sheet) 1 is generally fixed to a rotatable polishing plate 6 called a platen and a material to be polished 7 such as a semiconductor wafer is fixed to a support (polishing head) 8. A relative speed is generated between the polishing plate 6 and the support 8 due to the movement of the both and an electrolyte 10 is continuously fed onto the electropolishing pad (conductive sheet) 1 while a voltage is applied between the electropolishing pad (conductive sheet) 1 and the cathode layer 3 from a voltage application part 9, whereby the polishing operation is carried out.

By this operation, protrusions of a metal film on a semiconductor wafer surface are molten and removed electrochemically and the wafer is polished into flat. Thereafter, a semiconductor device is manufactured by dicing, bonding, packaging, and the like. The semiconductor device is used for arithmetic processing units, memories, and the like.

### EXAMPLES

In the following, the present invention will be described with reference to examples, but the present invention is not limited thereto.

### [Evaluation Method]

### (Evaluation of Polishing Characteristics)

Using Applied Reflexion LK ECMP (manufactured by Applied Materials) as a polishing apparatus and using the produced electropolishing pads (conductive sheets), polishing characteristics were evaluated.

Planarity were evaluated using a 12-inch patterned wafer (754 patterned wafer, manufactured by ATDF) with an initial level difference of about 6000 Å and an initial Cu film of about 10000 Å, by subjecting the patterned wafer to electropolishing under the following conditions and measuring the level difference in the part of L/S=100 μm/100 μm when the Cu film became 2000 Å or less. A smaller level difference means that the wafer is more excellent in the planarity, and a case where the level difference was 500 Å or less was evaluated as good and a case where the level difference exceeded 500 Å was evaluated as poor. The level difference measurement of the L/S part was carried out using a profilometer (manufactured by KLA, P-15). As the polishing conditions, an electrolyte (manufactured by AMAT, EP3.1) was added at 200 mL/min during polishing, with a polishing load of 0.5 to 1 psi, an applied voltage of 1.0 to 1.5 V, a rotation speed of the polishing plate of 21 rpm, and a rotation speed of the wafer of 20 rpm.

### First and Fourth Aspects of the Present Invention

### Example 1-1

### Production of Polyurethane Foam Layer

Polytetramethylene glycol having a number average molecular weight of 1000 and diethylene glycol were mixed at a molar ratio of 50/50 to prepare a glycol component. The glycol component and toluene diisocyanate (a 80/20 mixture of 2,4-isomer/2,6-isomer) were mixed with an excess of isocyanate monomers, then heated and stirred at 80° C. for 120 minutes, and thereafter unreacted isocyanate monomers were removed by distillation under reduced pressure to give an isocyanate-terminated prepolymer A.

Additionally, the glycol component and 4,4′-dicyclohexylmethane diisocyanate were mixed with an excess of isocyanate monomers, then heated and stirred at 80° C. for 120 minutes, and thereafter unreacted isocyanate monomers were removed by distillation under reduced pressure to give an isocyanate-terminated prepolymer B.

75 parts by weight of the isocyanate-terminated prepolymer A, 25 parts by weight of the isocyanate-terminated prepolymer B, 3 parts by weight of the toluene diisocyanate, and 3 parts by weight of 4,4′-dicyclohexylmethane diisocyanate were mixed to give a mixed prepolymer.

100 parts by weight of the mixed prepolymer and 3 parts by weight of a silicone surfactant (manufactured by Toray Dow Corning Silicone, SH-192) were added to a polymerization vessel and mixed, and the mixture was adjusted to 80° C. and defoamed under reduced pressure. Thereafter, the mixture was vigorously stirred with a mixer having a whipper-type stirring blade so as to incorporate air bubbles into the reaction system to prepare a cell dispersion liquid. The stirrer was changed to a planetary mixer and 4,4′-methylenebis(o-chloroaniline) preliminarily molten at 120° C. was added to the cell dispersion liquid so that the NCO/NH₂ equivalent ratio became 1.1. This mixed liquid was stirred for about 1 minute and poured into a pan-type open mold (casting vessel). When the fluidity of the mixed liquid was lost, the mold was put in an oven and post-cured at 110° C. for 6 hours, whereby a polyurethane foam block was obtained.

The polyurethane foam block heated to about 80° C. was sliced using a slicer (manufactured by AMITEC Corporation, VGW-125) to give a polyurethane foam sheet (average cell diameter: 50 μm, specific gravity: 0.86, Asker D hardness: 52 degrees). Then, the sheet was subjected to surface buffing using a buffing machine (manufactured by AMITEC Corporation) until the thickness thereof became 1.27 mm to give a sheet with precisely controlled thickness. Thereafter, a recessed structure in an XY lattice shape with a width of 2 mm, a pitch of 13.5 mm and a depth of 0.3 mm was formed on a surface of the sheet using a groove processing device (manufactured by Techno), whereby a polyurethane foam layer (80 cm×80 cm) was produced.

### (Production of Laminated Sheet)

On the recessed structure surface of the obtained polyurethane foam layer, an adhesive layer (manufactured by Sumitomo 3M, 467MP, thickness: 50 μm), a tin sheet (manufactured by Nippon Foil, thickness: 0.25 mm), and a flexible sheet (manufactured by NHK Spring, ES30, thickness: 2.4 mm, Asker C hardness: 25 degrees) were laminated in this order to produce a laminate. Thereafter, the laminate was vertically pressed (pressure: 3 MPa, time: 30 seconds) to adhere the tin sheet along the recessed structure of the polyurethane foam layer, whereby a laminated sheet was produced. The grooves on the tin sheet surface were high in surface uniformity and had round edges. Then, a doublesided tape was stuck to the polyurethane resin layer of the obtained laminated sheet. A number of through holes (diameter: 8 mm) were formed in portions other than the grooves using a hole processing device. Then, the laminated sheet was punched into a circle of a diameter of about 76 cm (30 inches). The surface electric resistance of the laminated sheet was 5.6×10⁻²Ω. The electric resistance was measured by DIGITAL MULTIMETER (manufactured by YOKOGAWA, 7552). The total surface area of the through holes was about 20% of the surface area of the laminated sheet.

### (Production of Electropolishing Pad (Conductive Sheet))

To the doublesided tape on the obtained laminated sheet, Cu mesh (manufactured by Mesh, thickness: 0.14 mm) as a cathode layer was bonded using a laminating machine. Using the laminating machine, another doublesided tape was stuck to the Cu mesh. Then, a cushion layer (manufactured by Rogers Corporation, PORON, thickness: 2.5 mm) was bonded to the doublesided tape using the laminating machine. Furthermore, using the laminating machine, still another doublesided tape was stuck to the cushion layer to produce an electropolishing pad (conductive sheet). The planarity of the electropolishing pad (conductive sheet) was good.

### Example 1-2

An electropolishing pad (conductive sheet) was produced by a similar method to that of Example 1-1 except that, in Example 1-1, after the number of through holes were formed in the laminated sheet, the laminated sheet was punched into a circle of a diameter of about 76 cm with two protrusions for anode 17 (length L: 25.4 mm, width W: 63.5 mm) as shown in FIG. 10. The planarity of the electropolishing pad (conductive sheet) was good.

### Comparative Example 1-1

To a vessel, 19000 g of DMF, 1000 g of KB (manufactured by LION, ketjen black), and 35000 g of 2 mmφ-balls were charged, and the components were mixed in a ball mill at 400 rpm for 20 minutes. To the obtained primary mixed liquid was added 11660 g of a DMF solution containing 20% by weight of a thermoplastic polyurethane resin, and the components were mixed in a ball mill at 400 rpm for 20 minutes. The obtained secondary mixed liquid was transferred to a stainless steel bat and DMF was removed in a vacuum drier of 100° C. The resulting sheet was hot-pressed (temperature: 190° C., pressure: 10 MPa) for 1 minute to give a resin sheet (thickness: 1.95 mm, electric resistance: 1.5×10²Ω). A mylar film (manufactured by Sekisui Chemical, 75 μm) having adhesive layers on both surfaces was bonded to the resin sheet using a laminating machine to give a resin sheet with a doublesided tape. Then, using a hole processing device, through holes (diameter: 6 mm) were formed in about 20% of the polishing surface. Thereafter, the resin sheet with the doublesided tape was punched into a circle of a diameter of about 76 cm (30 inches).

To the mylar film side of the resin sheet, Cu mesh (manufactured by Mesh, thickness: 0.14 mm) as a cathode layer was bonded using a laminating machine. Using the laminating machine, another mylar film (manufactured by Sekisui Chemical, 75 μm) having adhesive layers on both surfaces was bonded to the Cu mesh. Then, a cushion layer (manufactured by Rogers Corporation, PORON, thickness: 4 mm) was bonded to the mylar film using the laminating machine. Furthermore, using the laminating machine, still another mylar film (manufactured by Sekisui Chemical, 75 μm) having adhesive layers on both surfaces was bonded to the cushion layer to produce an electropolishing pad (conductive sheet). The planarity of the electropolishing pad (conductive sheet) was poor.

### Second Aspect of the Present Invention

### Example 2-1

### Production of Polyurethane Foam Layer

A polyurethane foam layer was produced by a similar method to that of Example 1-1.

### (Production of Laminated Sheet)

On the recessed structure surface of the obtained polyurethane foam layer, two adhesive layers (manufactured by Sumitomo 3M, 467MP, length: 80 cm, width: 50 cm, thickness: 50 μm) were placed in parallel, two tin sheets (manufactured by Nippon Foil, length: 80 cm, width: 40 cm, thickness: 0.25 mm) were placed thereon in parallel, and further a flexible sheet (manufactured by NHK Spring, ES30, length: 100 cm, width: 100 cm, thickness: 2.4 mm, Asker C hardness: 25 degrees) was laminated thereon to produce a laminate. Here, as shown in FIG. 2(b), opposed ends of the adhesive layers and opposed ends of the tin sheets were disposed on one recess of the polyurethane foam layer. Thereafter, the laminate was vertically pressed (pressure: 3 MPa, time: 30 seconds) to adhere the tin sheets along the recessed structure of the polyurethane foam layer and the opposed ends of the adhesive layers and the opposed ends of the tin sheets were buried in the recess, whereby a laminated sheet was produced. The grooves on the tin sheet surfaces were high in surface uniformity. Then, a doublesided tape was stuck to the polyurethane resin layer of the obtained laminated sheet. A number of through holes (20 mm×20 mm) were formed so as to connect the grooves using a laser processing device. Then, the laminated sheet was punched into a circle of a diameter of about 76 cm (30 inches). The surface electric resistance of the laminated sheet was 5.6×10⁻²Ω. The electric resistance was measured by DIGITAL MULTIMETER (manufactured by YOKOGAWA, 7552). The total surface area (aperture ratio) of the through holes was about 45% of the surface area of the laminated sheet.

### (Production of Electropolishing Pad)

To the doublesided tape on the obtained laminated sheet, Cu mesh (manufactured by Mesh, thickness: 0.14 mm) as a cathode layer was bonded using a laminating machine. Using the laminating machine, another doublesided tape was stuck to the Cu mesh. Then, a cushion layer (manufactured by Rogers Corporation, PORON, thickness: 2.5 mm) was bonded to the doublesided tape using the laminating machine. Furthermore, using the laminating machine, still another doublesided tape was stuck to the cushion layer to produce an electropolishing pad. The planarity of the electropolishing pad was good.

### Example 2-2

An electropolishing pad was produced by a similar method to that of Example 2-1 except that, in Example 2-1, after the number of through holes were formed in the laminated sheet, the laminated sheet was punched into a circle of a diameter of about 76 cm with two protrusions for anode 17 (length L: 25.4 mm, width W: 63.5 mm) as shown in FIG. 10. The planarity of the electropolishing pad was good.

### Third Aspect of the Present Invention

### Example 3-1

### Production of Polyurethane Foam Layer

A polyurethane foam layer was produced by a similar method to that of Example 1-1.

### (Production of Polishing Layer)

On the recessed structure surface of the obtained polyurethane foam layer, a pressure-sensitive adhesive layer (manufactured by Sumitomo 3M, 467MP, thickness: 50 μm), a tin sheet (manufactured by Nippon Foil, thickness: 0.25 mm), and a flexible sheet (manufactured by NHK Spring, ES30, thickness: 2.4 mm, Asker C hardness: 25 degrees) were laminated in this order to produce a laminate. Thereafter, the laminate was vertically pressed (pressure: 3 MPa, time: 30 seconds) to adhere the tin sheet along the recessed structure of the polyurethane foam layer, whereby a laminated sheet was produced. Then, a doublesided tape (with a release sheet) was stuck to the polyurethane resin layer of the obtained laminated sheet. A number of through holes (20 mm×20 mm) were formed using a laser processing device, as shown in FIG. 11. Then, the laminated sheet was punched into a circle of a diameter of about 76 cm (30 inches) to produce a polishing layer. The surface electric resistance of the polishing layer was 5.6×10⁻²Ω. The electric resistance was measured by DIGITAL MULTIMETER (manufactured by YOKOGAWA, 7552). The total surface area (aperture ratio) of the through holes was about 45% of the surface area of the polishing layer.

### (Production of Pressure-Sensitive Adhesive Copper Mesh)

Copper mesh (manufactured by Mesh, thickness: 0.14 mm) was bonded to a pressure-sensitive adhesive tape having a pressure-sensitive adhesive layer on one surface of a release sheet (PET film, thickness: 100 μm) using a laminating machine to produce pressure-sensitive adhesive copper mesh.

### (Production of Electropolishing Pad)

The obtained pressure-sensitive adhesive copper mesh was half-cut so as not to cut the release sheet using a Thomson pressing machine to form grooves (width: 1 mm) penetrating the copper mesh and the pressure-sensitive adhesive layer. Thus, a cathode layer having a first copper cathode region, a second copper cathode region and a third copper cathode region, as shown in FIG. 5(b), was formed. Then, the pressure-sensitive adhesive copper mesh was punched into a circle of a diameter of about 76 cm (30 inches). Thereafter, the release sheet was peeled off of the doublesided tape on the polishing layer to expose the pressure-sensitive adhesive layer. To the pressure-sensitive adhesive layer, the cathode layer of the pressure-sensitive adhesive copper mesh was bonded using a laminating machine. Then, the release sheet of the pressure-sensitive adhesive copper mesh was peeled off to expose the pressure-sensitive adhesive layer. To the pressure-sensitive adhesive layer, a cushion layer (manufactured by Rogers Corporation, PORON, thickness: 2.5 mm) was bonded using the laminating machine. Further, the cushion layer and a magnetic SUS plate were bonded together with a doublesided tape to produce an electropolishing pad.

Since the electropolishing pad according to the third aspect of the present invention has a zoned cathode layer having two or more copper cathode regions, the removal rate of a metal film on a wafer surface can be regulated area by area by regulating the voltages applied to the copper cathode regions. Therefore, use of the electropolishing pad according to the present invention improves flatness and in-plane uniformity of the metal film on the wafer surface.

From the above-mentioned results, it can be understood that the electropolishing pad (conductive sheet) of the present invention is excellent in planarity. Additionally, the electropolishing pad (conductive sheet) of the present invention has characteristics such as 1) a high polishing rate due to the very low surface electric resistance and ease of electrochemical melting and removal of the metal film on the wafer surface and 2) effective suppression of occurrence of scratches.

1. A method of manufacturing an electropolishing pad, comprising the steps of:
laminating a tin sheet on and along a recessed structure surface of a resin layer to produce a laminated sheet having grooves in a tin sheet surface; and
forming through holes penetrating the tin sheet and the resin layer in the laminated sheet.

2. The method according to claim 1, wherein an adhesive layer, the tin sheet, and a flexible sheet are laminated in this order on the recessed structure surface of the resin layer to produce a laminate, and the laminate is pressed to produce the laminated sheet.

3. A method of manufacturing an electropolishing pad, comprising the steps of:
laminating a plurality of tin sheets in parallel on and along a recessed structure surface of a resin layer and burying opposed ends of the tin sheets in one recess to produce a laminated sheet having grooves in tin sheet surfaces; and
forming through holes penetrating the tin sheets and the resin layer in the laminated sheet.

4. The method according to claim 3, wherein an adhesive layer, the tin sheets, and a flexible sheet are laminated in this order on the recessed structure surface of the resin layer and the opposed ends of the tin sheets are disposed on one recess to produce a laminate, and the laminate is pressed to produce the laminated sheet.

5. A method of manufacturing an electropolishing pad, comprising the steps of:
bonding a copper sheet to a pressure-sensitive adhesive layer of a pressure-sensitive adhesive tape having the pressure-sensitive adhesive layer on one surface of a release sheet to produce a pressure-sensitive adhesive copper sheet;
forming grooves penetrating the copper sheet and the pressure-sensitive adhesive layer in the pressure-sensitive adhesive copper sheet to form a cathode layer having two or more copper cathode regions;
bonding a polishing layer to the cathode layer; and
peeling the release sheet off to expose the pressure-sensitive adhesive layer and bonding a cushion layer to the pressure-sensitive adhesive layer.

6. A method of manufacturing an electropolishing pad, comprising the steps of:
bonding a copper sheet to a pressure-sensitive adhesive layer of a pressure-sensitive adhesive tape having the pressure-sensitive adhesive layer on one surface of a release sheet to produce a pressure-sensitive adhesive copper sheet;
bonding a polishing layer to another surface of the copper sheet;
forming, from the release sheet side, grooves penetrating the pressure-sensitive adhesive copper sheet to form a cathode layer having two or more copper cathode regions; and
peeling the release sheet off to expose the pressure-sensitive adhesive layer and bonding a cushion layer to the pressure-sensitive adhesive layer.

7. A conductive sheet comprising at least a laminated sheet obtained by laminating a tin sheet on and along a recessed structure surface of a resin layer, wherein the laminated sheet has grooves in the tin sheet surface and through holes penetrating the tin sheet and the resin layer.

8. A method of manufacturing a semiconductor device, comprising the step of polishing a metal film on a semiconductor wafer surface using the conductive sheet according to claim 7.
